(19) United States
(12) Patent Application Publication
(10) Pub. No.: US 2025/0111599 A1
(43) Pub. Date: Apr. 3, 2025

(54) TEMPORAL SHADING RATE CONTROLLER FOR DECOUPLED SHADING

(71) Applicants: Advanced Micro Devices, Inc., Santa Clara, CA (US); ATI Technologies ULC, Markham (CA)

(72) Inventors: Guennadi Riguer, Markham (CA); Michal Adam Wozniak, Santa Clara, CA (US)

(73) Assignees: Advanced Micro Devices, Inc., Santa Clara, CA (US); ATI Technologies ULC, Markham (CA)

(21) Appl. No.: 18/477,886

(22) Filed: Sep. 29, 2023

(51) Int. Cl. G06T 15/80; G06T 17/20

(52) U.S. Cl. CPC G06T 15/80; G06T 17/20

(57) ABSTRACT

A technique for rendering is provided. The technique includes performing a visibility pass that designates portions of shade space textures visible in a scene, wherein the visibility pass generates tiles that cover the shade space textures visible in the scene; performing a temporal rate controller operation; performing a shade space shading operation on the tiles that cover the shade space textures visible in the scene based on a temporal shading rate output by the temporal rate controller operation, wherein only a subset of samples in the tiles that cover the shade space textures visible in the scene are shaded in the shade space shading operation; and performing a reconstruction operation using output from the shade space shading operation to produce a final scene.

### BACKGROUND

Three-dimensional graphics processing involves rendering three-dimensional scenes by converting models specified in a three-dimensional coordinate system to pixel colors for an output image. Improvements to three-dimensional graphics processing are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 is a block diagram showing additional details of the graphics processing pipeline illustrated in FIG. 2;

FIG. 4 illustrates a set of decoupled shading operations, according to an example;

FIG. 5 illustrates operations for the visibility pass and texture marking operations, according to an example;

FIG. 6 illustrates example shade space shading operations for the shade space shading operations of FIG. 4;

FIG. 7 illustrates an example reconstruction operation;

FIG. 8 illustrates the movement over time of a detail within a tile, according to an example;

FIG. 9 illustrates a feedback mechanism for determining a difference between corresponding samples shaded over time, and then adjusting the temporal shading rate up or down, or maintaining the current temporal rate, depending on the result, according to an example.

FIG. 10 illustrates the movement over time of a detail within a tile, according to a further example;

FIGS. 11A and 11B show an example for illustrating the application of temporal shade rate equalization applied spatially;

FIG. 12 includes graphs illustrating application of temporal shade rate equalization applied spatially to the example shown in FIGS. 11A and 11B;

FIG. 13 is a further example for illustrating application of temporal shade rate equalization spatially;

FIG. 14 is a flow diagram of a method for performing temporal shading rate control, according to an example.

### DETAILED DESCRIPTION

A technique for rendering is provided. The technique includes performing a visibility pass that designates portions of shade space textures visible in a scene, wherein the visibility pass generates tiles that cover the shade space textures visible in the scene; performing a temporal rate controller operation; performing a shade space shading operation on the tiles that cover the shade space textures visible in the scene based on a temporal shading rate output by the temporal rate controller operation, wherein only a subset of samples in the tiles that cover the shade space textures visible in the scene are shaded in a single shade space shading operation; and performing a reconstruction operation using output from the shade space shading operation to produce a final scene.

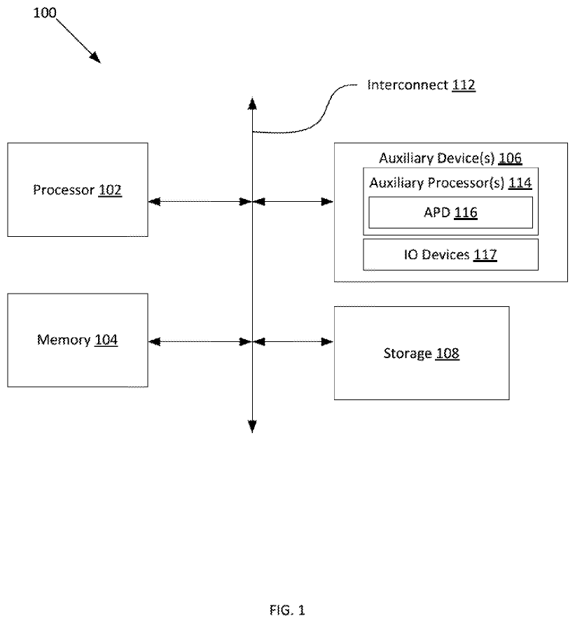

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

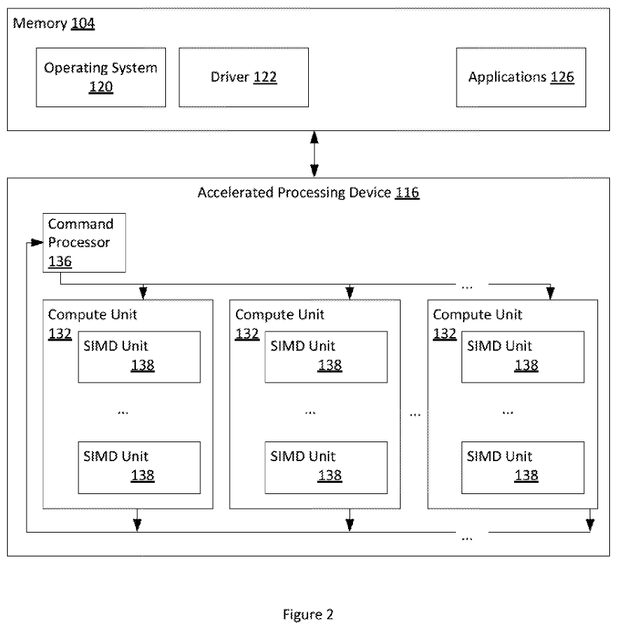

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous”execution occurs in the case of a wavefront that is larger than the number of lanes in a SIMD unit 138. In such a situation, wavefronts are executed over multiple cycles, with different collections of the work-items being executed in different cycles. A command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus, in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

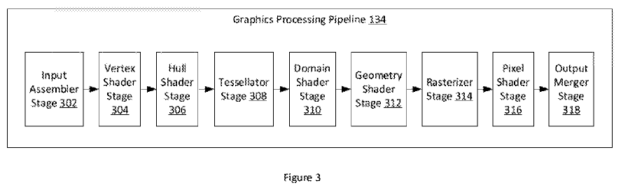

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

It is possible to perform rendering in a “decoupled” manner. Decoupled rendering involves decoupling sample shading operations from other operations in the pipeline such as geometry sampling and actual application of the shading results to the objects of a three-dimensional scene. In “typical” rendering such as forward rendering, a rendering pipeline processes triangles, transforming the vertices of such triangles from world space to screen space, then rasterizes the triangles, generating fragments for shading by the pixel shader. The pixel shader shades such fragments and outputs visible fragments to the pixel buffer for final output. As can be seen, in such rendering operations, the rate at which pixel shading operations occur is directly related to the rate at which the geometry sampling is performed during rasterization. Advantage can be gained by decoupling the rate at which shading operations occur from the rate at which other operations (e.g., geometry operations) occur. Specifically, it can be possible to reduce the heavy workload of complex pixel shading operations while still generating frames at a high frame rate to reflect changes in geometry (e.g., camera position, rotation and scene geometry movement, rotation, and scaling) quickly over time.

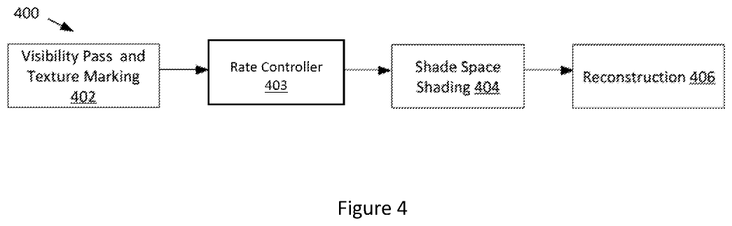

FIG. 4 illustrates a set of decoupled shading operations 400, according to an example. The set of decoupled shading operations 400 includes a visibility pass and shade space marking operation 402, a shade space shading operation 404, and a reconstruction operation 406. In some examples, any of these operations is performed by one or more of software executing on a processor (such as the compute units 132), hardware (e.g., hard-wired circuitry), or a combination of software and hardware. In various examples, any of this software includes software executing on the processor 102 (e.g., an application), software executing in the APD 116 (e.g., shader programs), any other software, or any combination thereof. In various examples, the hardware includes any of the processors illustrated (e.g., processor 102, APD 116), or other circuitry or processors not illustrated. In this disclosure, phrases such as “the APD 116 performs a task” is sometimes used. This should be understood as meaning that any technically feasible element (e.g., the software or hardware) performs such task. In addition, although various operations are described as being performed by the APD 116, in other examples, such operations are performed by other elements such as the processor 102 or another hardware or software element not described. Herein, where it is stated that software performs an operation, this should be understood as meaning that software executing on a processor performs the operation and thus that the processor performs that operation.

As a whole, the operations of FIG. 4 involve four “phases”: a visibility and marking phase, a temporal shading rate determination phase, a shade space texture shading phase and a reconstruction phase. The shade space texture shading phase includes shading onto shade space texture for a scene. The shade space textures can be thought of as “canvases” to which shading operations are applied. The canvases are applied to the objects of a scene in the reconstruction phase. It is possible to decouple the temporal rate at which the shade space shading phase occurs from the rate at which the reconstruction phase occurs, providing benefits such as reduction of shading operation workload while still allowing for generating output frames at a high rate.

As described above, the objects of a scene each have one or more shade space textures. The shade space textures are mapped to the surfaces of such objects and colors in the shade space textures are applied to the objects during reconstruction 406. Utilizing the shade space textures in this manner allows for shading operations (e.g., the shade space shading operations 404) to occur in a temporally “decoupled” manner as compared with the other rendering operations.

The visibility and shade space marking pass 402 involves determining and marking which portions of the shade space textures are visible in a scene. In some examples, the scene is defined by a camera and objects within the scene, as well as parameters for the objects. In some examples, a portion of a shade space texture is visible in the event that that portion appears in the final scene. In some examples, the portion appears in the final scene if the portion is within the camera view, faces the camera, and is not occluded by other geometry. In some examples, the visibility pass and shade space marking operation 402 results in generating groups of samples, such as tiles, that are to be shaded in the shade space shading operation 404. Each tile is a set of texture samples of a shade space texture that is rendered into in the shade space shading operation 404 and then applied to the geometry in the reconstruction 406 operation. In some examples, each such tile is a fixed size (e.g., 8×8 texture samples or “texels”).

A temporal rate controller operation 403 applies adaptive techniques to determine a temporal shading rate for one or more subsets of samples from the portions of the shade space texture designated as visible by the visibility pass. In some examples, the adaptative sampling techniques used in the temporal rate controller operation 403 sparsely designate a temporally varying subset of the samples for shading as described herein. In other cases, the samples designated for shading are not sparse. For example, on disocclusion or large error within a tile, the temporal rate controller operation 403 designates all samples in the tile are designated for shading. In such an example, temporal rate controller operation 403 sparsely designates samples within the tile in subsequent updates. In other examples, temporal rate controller operation 403 sparsely designates for shading tile locations within the shade space. As discussed more fully below, the adaptive techniques are operable on a group of spatially coherent samples in the shade space, which could be organized in a tile or any other arbitrary spatial arrangement.

The shade space shading operation 404 includes shading the visible portions of the shade space textures according to visibility and subject to applying a temporally-adaptive shading rate. In some examples, these shading operations are operations that are typically applied in the pixel shader stage 316 in “typical” rendering. Such operations include texture sampling (including filtering), applying lighting, and applying any other operations that would be performed in the pixel shader stage 316.

The reconstruction operation 406 includes applying the shade space textures to the geometry of the scene to result in a final image. In some examples, the reconstruction operation 406 processes the scene geometry through the world space pipeline, including applying the operations of the vertex shader stage 304 (e.g., vertex transforms from world-space to screen space) and the rasterizer stage 314 to generate fragments. The reconstruction operation 406 then includes applying the shade space texture to the fragments, e.g., via the pixel shader stage 316, to produce a final scene which is output via the output merger stage 318. Note that the operations of the pixel shader stage 316 in reconstruction 406 are generally much simpler and less computationally intensive than the shading operations that occur in the shade space shading operations 404. For example, while the shade space shading operations 404 perform lighting, complex texture filtering, and other operations, the reconstruction operation 406 is able to avoid many such complex pixel shading operations. In one example, the reconstruction operation 406 performs texture sampling with relatively simple filtering and omits lighting and other complex operations.

As stated above, it is possible to apply the shade space shading operation 404 at a different frequency than the reconstruction operation 406. In other words, it is possible to use the information generated by the shade space operation 404 in its entirety or selectively in multiple successive reconstruction operations 406 (or reconstruction “frames”). Thus, it is possible to reduce the computational workload of the complex shading operations 404 while still generating output frames relatively quickly. The decoupled shading operations 400 will now be described in greater detail.

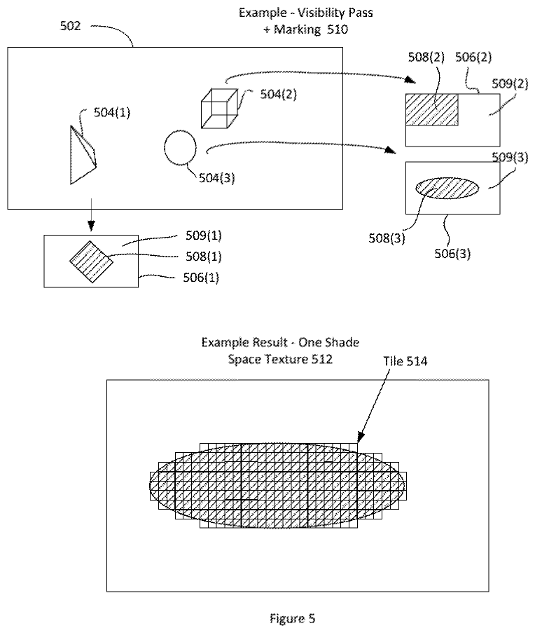

FIG. 5 illustrates operations for the visibility pass and texture marking operations 402, according to an example. Herein, the term “visibility pass 402” is used interchangeably with “visibility pass and texture marking operations 402.” The example visibility pass 402 is performed for a scene 502 which includes a number of objects 504. In addition, each object 504 has an associated shade space texture 506 which has a visible portion 508 and a non-visible portion 509. As can be seen, the example visibility pass 510 results in the designation of the visible portion 508 of the associated shade space texture 506.

In an example 512, the visibility pass 402 designates the visible portions 508 of the shade space textures 506 by generating tiles 514 that cover the visible portions in the following manner. The visibility pass 402 performs operations of the graphics processing pipeline 134 and generates tiles for the portions of the shade space texture 506 that are visible in the scene. Each tile 514 represents a portion of the shade space texture 506 that is to be shaded in the shade space shading operation 404. Tiles that are not generated are not shaded in the shade space operation 404.

In some examples, the visibility pass 402 generates tiles by using the graphics processing pipeline 134. More specifically, the geometry of the scene 502 is processed through the graphics processing pipeline 134. Information associating each fragment with a shade space texture flows through the graphics processing pipeline 134. When the final image is generated, this information is used to identify which portions of which shade space textures 506 are actually visible. More specifically, because only visible fragments exist in the final output image, the information associated with such fragments is used to determine which portions of the shade space textures 506 are visible.

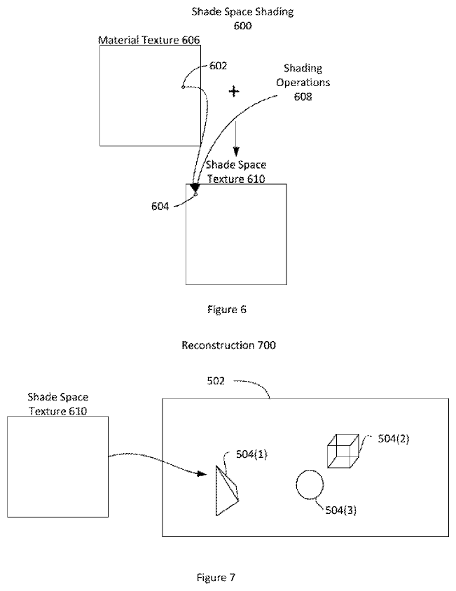

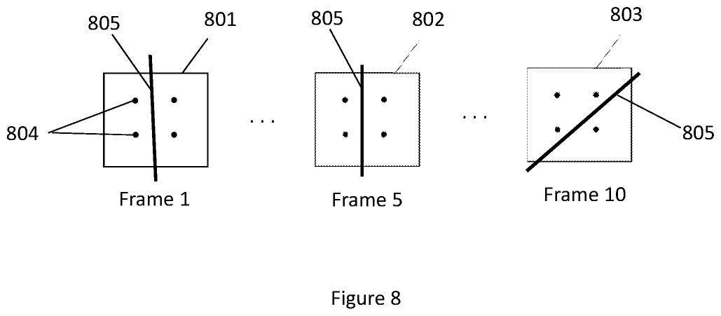

FIG. 6 illustrates example shade space shading operations 600 for the shade space shading operations 404 of FIG. 4. The APD 116 performs shade space shading 600 by sampling a material texture 606 within a sample area 602 to obtain a texture color and applying shading operations 608 (e.g., lighting and/or other operations) as a result to generate a shade space color sample 604 for the shade space texture 610. In some examples, the shade space shading operations 600 generates texels for the entirety of each of the tiles 514 that are generated as a result of the visibility pass 402. FIG. 7 illustrates an example reconstruction operation 700. In the reconstruction operation 700, the shade space texture 610 is applied to the objects 504 within the scene. As stated elsewhere herein, in some examples, this application is performed via texture sampling operations that sample the shade space texture 610 and apply such samples to the objects 504 of the scene 502.

One problem with decoupled shading solutions is that they suffer from higher baseline shading costs. To maintain high image quality, the shading rates have to be higher than the sample rates of the final image according to the sampling theorem. The techniques discussed below solve this problem, allowing temporal reuse of shaded samples under dynamic shading conditions while maintaining high image quality. While the system shown in FIG. 4 is useful for limiting the shading operation to portions of the shade space texture designated for shading by the visibility pass, rate temporal controller operation 403 can achieve a further lessening of shading operations through application of adaptive temporal shading rates to static or slowly changing portions of the shade space texture designated as visible by the visibility pass. As discussed above, the decoupled shading system generates the final image from a set of samples from a shade space. In some examples, the adaptative sampling techniques discussed herein only sparsely reshade a subset of the samples needed for reconstruction, and the sparsely reshaded samples are then reused for multiple frames based on the output of temporal rate controller 403. In other cases, the samples designated for shading are not sparse. For example, on disocclusion or large error within a tile, the temporal rate controller operation 403 designates all samples in the tile are designated for shading. In such an example, temporal rate controller operation 403 sparsely designates samples within the tile in subsequent updates. In other examples, temporal rate controller operation 403 sparsely designates for shading tile locations within the shade space.

The temporal shade rate control techniques are operable on a group of spatially coherent samples in the shade space, which could be organized in a tile or any other arbitrary spatial arrangement. In some examples, temporal shade rate controller 403 tracks each sample that has been shaded with a set of properties (e.g., sample validity, age, rate of change). Temporal shade rate controller 403 periodically checks these properties, and updates them for validity. In some examples, the temporal shade rate controller 403 performs these checks and updates by comparing a small subset of the samples shaded by the shade space shading operation 404 with previous values. Based on the updated properties, tracked historical information and external inputs, temporal shade rate controller 403 re-classifies each sample in a group. Examples of tracked historical information used in re-classifying include prior shaded data as well as prior values of properties. For example, age of a sample could be considered something reflecting a historical property/information. Examples of external inputs used in re-classifying include inputs defining shadow edges, material properties, scene geometry and texture pre-analysis. Temporal shade rate controller 403 uses this classification to drive the temporal shading rate. These classifications can also be used for sample prediction (in case of missing samples due to them being invalidated) and reconstruction operation for 406. While FIG. 4 shows temporal rate controller 403 before shade space shading operation 404 in the pipeline, in some embodiments the function of temporal shade rate controller 403 is embedded in shade space shading operation 404. This positioning allows for immediate reshading of samples classified as invalid.

As mentioned above, in some examples, the adaptative sampling techniques discussed herein only sparsely shade a subset of the samples needed for reconstruction, and the sparsely shaded samples are then reused for multiple frames based on the output of temporal rate controller 403. The term “sparse shading operation” as used herein refers to the shading of only such a subset of the samples during a shading operation. In some examples, these sparsely shaded samples are temporally cached for reuse and drive a feedback loop in rate controller operation 403. In this approach, shaded samples have a temporal persistence, and dynamic reshading and invalidation of samples occurs probabilistically based on shading conditions and temporally tracked sample group characteristics. Utilizing knowledge about subsequent sample reconstruction and filtering stages, one can additionally optimize selection of shaded samples. In one example where knowledge of a reconstruction filter affects sample selection, if the reconstruction filter is large and takes contributions from multiple samples, rate controller operation 403 assumes that a contribution of a single invalid sample surrounded by up to date samples is relatively small, so reshading priority is given to a group of older samples that might be less “bad”, but have nothing to be averaged with to cause them to appear more “correct.” In other examples, rate controller operation 403 applies knowledge of texture filtering in designating samples for reshading. For example, in a case where a large anisotropic filter is applied, rate controller operation 403 assumes that the filter provides some averaging of values that could make shaded samples appear less “wrong” perceptually, and therefore does not give re-shading priority to such samples.

As discussed above, the adaptative sampling techniques only sparsely reshade a subset of the samples needed for reconstruction. In other words, out of all of the samples that exist in the shade space textures, the adaptive sampling technique reshades only a subset of the samples, while updates to other samples are temporally accumulated. In some examples, the adaptive shading approach discussed herein has fine-grained control of shading rates all the way down to individual samples (as opposed to tiles or blocks of the shade or image space) and takes into account the importance of samples according to their potential contribution to the image. In other embodiments, the techniques are applied across tiles or groups of tiles. Various examples are discussed below.

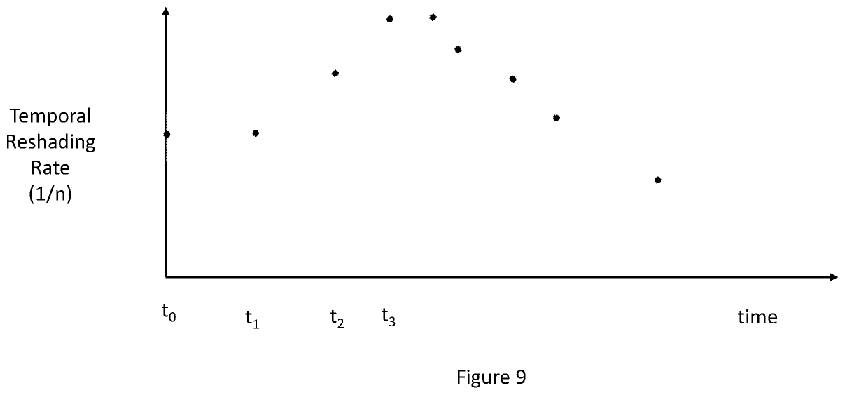

A first example of an adaptive technique for controlling the temporal shading rate will be explained using the illustration shown in FIG. 8. Tiles 801, 802 and 803 represent corresponding tiles from a sequence of frames analyzed by temporal rate controller 403. In the sequence, the position of detail 805 moves over time. While the position of detail 805 moves a relatively small amount from frame 1 to frame 5, a more drastic change in the position of detail 805 is shown between frames 5 and 10. Initially, in frame 1, temporal rate controller 403 designates four samples 804 to be shaded during the shade space shading operation 404 at a temporal rate corresponding to 1/n, where n=5. In other words, temporal rate controller 403 initially instructs the shade space shading operation 404 to only shade pixels 804 every 5th frame (resulting in reuse of these shaded samples for frames 2-4). In connection with processing of frame 5, samples 804 are shaded again by the shade space operation 404, and the results of the shading of samples 804 for frame 5 are compared with the corresponding values from frame 1. Since detail 805 only moved slightly between frames 1 and 5, the comparison indicates only a small difference. As a result of the difference being small, rate controller 403 maintains the temporal shade rate of 1/5. In connection with processing of frame 10, samples 804 are shaded again by the shade space operation 404, and the results of the shading of samples 804 for frame 10 are compared with the corresponding values from frame 5. Since detail 805 moved drastically between frames 5 and 10, the comparison indicates a significant difference. As a result of this difference, rate controller 403 increases the temporal shade rate to, for example, every third frame (1/3) going forward. Each time rate controller operation 403 goes through this process to determine whether or not to adjust the temporal sampling rate is referred to as an iteration of the feedback process.

In some examples, rate controller 403 guarantees reshading of some samples at least on some minimal reshading interval. In some cases, that interval would be equal to a single frame. In some cases with high frame rates, rate controller 403 amortizes reshading across multiple frames. For example, rate controller 403 targets 30 Hz as a minimal reshade interval for some of the samples within a tile. If the actual frame rate is 120 Hz, rate controller 403 designates the samples for reshading every 4th frame. In some examples, rate controller 403 stochastically varies the samples designated for reshading at each reshade interval, as well as how many samples are reshaded in one time. For example, in the case of an 8×8 tile (64 samples) where rate controller 403 designates 4 samples for shading per reshading interval, the whole tile will be updated in 16 intervals. If, at the same reshade rate, rate controller 403 designates 8 samples for reshading per interval, then the tile will be updated in 8 intervals. In one example of a case where tile content is very static, rate controller 403 lowers the minimal reshade interval rate, so as to provide fewer reshades per time. In this example, rate controller 403 quickly increases the shading rate at the first sign of changing content.

While in the example of FIG. 8 the frequency of reshading samples is varied, rate controller 403 is also operable to vary a number of samples reshaded each time. For example, in one case of relatively fast changing content, rate controller 403 choses to update the tile in 2 frames or intervals. In that case, rate controller 403 designates 32 samples for shading on one frame, and on another designates the remaining 32 samples for shading. Additionally, in some cases rate controller 403 is operable to dither a pattern (e.g. a checkerboard pattern) of samples designated for reshading either instead of, or in addition to, varying the number of samples designated for reshading each time. In other cases, rate controller 403 stochastically distributes the samples designated for reshading each time using, e.g., a noise function. In some examples, rate controller 403 is operable to vary both the reshade interval frequency and grouping of samples shaded each interval. In some examples, sample selection per interval is such that rate controller 403 guarantees full tile reshade in the smallest number of intervals possible. In some cases, rate controller 403 applies an exception to this general rule by forced shading of samples due to disocclusion or invalidation of samples.

In one example, the shading rate controller 403 determines the temporal shading rate based on a predetermined budget of shaded samples. There are many options for defining budgetary constraints depending on requirements. In one example, when a stable frame rate delivery is a goal, the number of shaded samples that could be processed could be estimated by dividing the allotted frame time by the average cost of shading per unit of time. In other cases, the budget could be adjusted based on the content in either static or dynamic manner. For example, if the shading rate controller 403 is aware of the happening of an explosion that will add a lot of pixel processing due to smoke particles, it could artificially increase the budget to account for such event. Within the budget, an optimum temporal shading rate is selected for shading in order to minimize the visual and perceptible impact of reusing shaded samples for multiple frames.

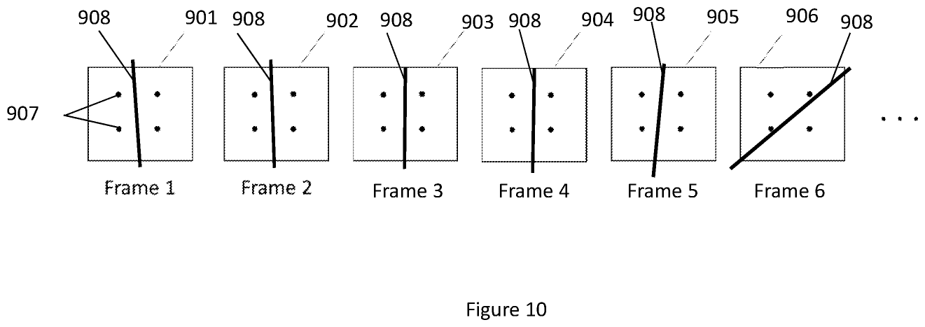

FIG. 9 illustrates a feedback mechanism for determining differences between corresponding samples shaded over time, and then adjusting the temporal shading rate up or down, or maintaining the current temporal rate, depending on the result. The feedback mechanism is discussed in conjunction with the example shown in FIG. 8. Although a specific collection of samples is illustrated in this example, shade rate controller 403 is capable to apply the feedback technique to any collection of samples in any iteration of the feedback process. In general, visibility pass 402 designates portions of shade space textures visible in a scene, including, for example, tiles that cover the shade space textures visible in the scene. At the start of the temporal reshading process, rate controller 403 identifies tiles that should be shaded in their entirety to start the process of temporal reshading and accumulation. The rate controller 403 then identifies an initial temporal shading rate used for shading a sparse number of samples over the shade space textures visible in the scene. On disocclusion or full tile invalidation due to too much accumulated shading error, rate controller 403 designates tiles to be fully shaded and establishes a new temporal rate going forward.

In some examples, the shade space operation 404 shades the samples. Alternatively, at some shading is performed by the temporal rate controller operation 403. In some such embodiments, temporal rate controller operation 403 shades designated test samples or samples dictated by the temporal shade rate but not contributing to error estimation. Regardless of whether shading is performed by the local temporal rate controller 403b or the shade space shading operation 404, the samples shaded are reused until the next time they are identified for reshading by the temporal rate controller operation 403. At a subsequent iteration, the rate controller operation 403 is performed again to determine if the temporal shading rate should be adjusted. Here, the most recent results of the shading of the sparse number of samples are compared with prior shading results for spatially corresponding samples and the differences are determined. Depending on the magnitude of the differences, the rate controller operation 403 either adjusts up, adjusts down or holds constant the temporal sampling rate of samples designated to be shaded during shade space operation 404.

Typically, there is some shading happening on every shading interval and the temporal shade rate controller 403 is constantly re-evaluating the temporal shading rate. In some embodiments, the temporal shading rate controller 403 shades at the very least a small number of samples which it uses for detecting changing content by evaluating or estimating a shading error. The shaded test samples are leveraged for updating tile samples whenever possible, but there could be some circumstances when they are rejected. In some embodiments, some or all of the samples shaded in a shade interval (as dictated by the temporal shading rate controller 403) are designated as test samples that drive the feedback loop of the local temporal shading rate controller 403.

Alternatively, temporal shading rate controller 403 performs error detection related shading less frequently than a single shading interval, for example, when the temporal rate is very low. In one such example, the minimal reshading rate for a particular 8×8 tile is 1/16 and error detection requires 4 samples to be shaded. In that case the tile is fully reshaded in 16 shade intervals. In another case with a 1/32 rate and 4 shaded test samples, temporal shading rate controller 403 would perform error detection every 2 shading intervals and the whole tile will be refreshed over 32 intervals. The shaded interval referred to above could be a single delivered frame or multiple of those.

Referring now to FIG. 9, at time to rate controller 403 initially selects a temporal sampling rate of 1/5 for the shade space operation 404, which indicates the tile fill be fully reshaded over the course of 5 frames or reshade intervals if they are different. Time to corresponds to Frame 1 as shown in FIG. 8. At time t₁ in FIG. 9 (corresponding to Frame 5 in FIG. 8), samples 804 are shaded again by the shade space operation 404, and rate controller 403 identifies differences between the results of the shading of samples 804 with the corresponding shading values previously generated for Frame 1. In the example shown, the differences fail to exceed a threshold. At each of frames 2-9, temporal shade rate controller 403 re-evaluates the temporal shading rate by shading at least a small number of samples (e.g., a subset of samples 804 that is less than the four samples shown) which it uses for detecting changing content by evaluating or estimating a shading error. In this example, temporal shading rate controller 403 detects only a small error for frames 2-9. As a result, rate controller 403 maintains the same temporal sampling rate (1/5) during this time. In FIG. 9, frame 5 from FIG. 8 corresponds to time t₁. At time t₂ in FIG. 9 (corresponding to Frame 10 in FIG. 8), samples 804 are shaded again, and rate controller 403 identifies larger differences between the results of the shading of samples 804 with the corresponding shading values previously generated for Frame 9. In the example shown, the differences exceed a threshold. As a result, rate controller 403 increases the temporal sampling rate to 1/3) at time t₂. At each of frames 11-12, temporal shade rate controller 403 re-evaluates the temporal shading rate by shading at least a small number of samples which it uses for estimating a shading error. In this example, temporal shading rate controller 403 detects only a small error for frames 11-12, resulting in the temporal shading rate being maintained at 1/3 during this time. At time t₃ in FIG. 9 (corresponding to Frame 13 in the sequence (not shown))), samples 804 are shaded again, and rate controller 403 identifies differences between the results of the shading of samples 804 with the corresponding shading values previously generated for Frame 12. In the example shown, the differences again exceed a threshold. As a result, rate controller 403 increases the temporal sampling rate to 1/2) at time t₃. After each of the subsequent frames, the system uses feedback from the previous iteration to determine whether to increase, decrease or hold constant the temporal sampling rate.

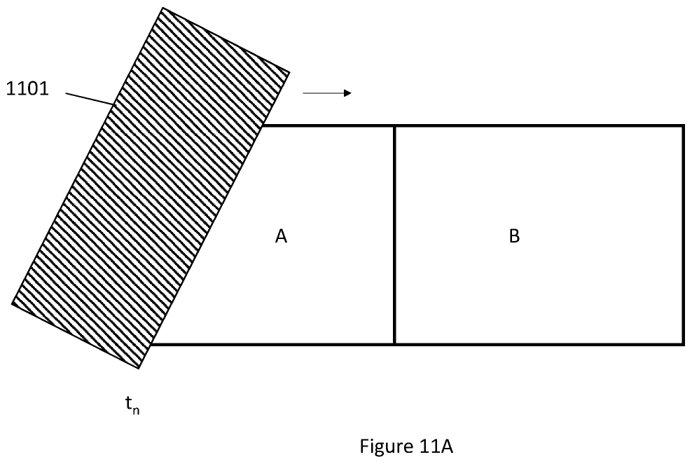

FIG. 10 illustrates the movement over time of a detail within a tile, according to a further example. The example in FIG. 10 is useful for explaining certain advantages of the adaptive temporal shading techniques disclosed herein as compared to using temporal gradients for approximating when in the future to reshade samples 907. In the example of FIG. 10, visibility pass 402 designates tiles 901-906 as visible. In the example, a detail 908 moves slowly in Frames 1-5, and then moves drastically between Frames 5 and 6. Based on the slow movement of detail 908 earlier in the frame sequence, application of temporal gradients for approximating when in the future to reshade samples would typically result in a failure to reshade samples for Frame 6, causing the drastic movement of detail 908 at Frame 6 to be missed. By contrast, a granular application of the adaptive temporal shade rate control techniques disclosed herein will identify the movement of detail 908 at Frame 6 in time to reshade the samples so that the detail is not missed.

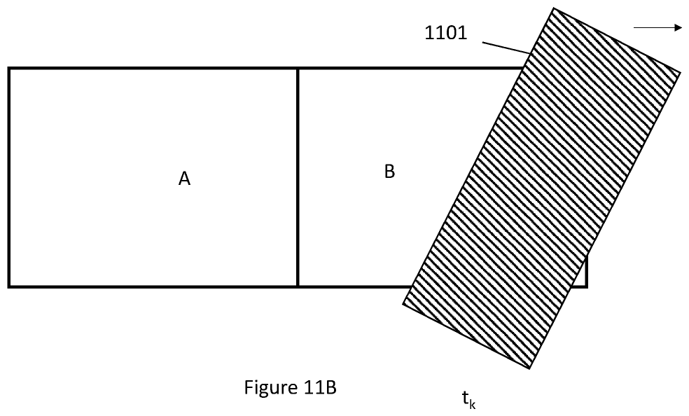

FIGS. 11A-11B show an example for illustrating the application of temporal shade rate equalization applied spatially. In FIGS. 11A and 11B, there are two neighboring tiles labeled A and B. In FIG. 11A, shadow 1101 is moving across tile A in the direction of the arrow toward tile B at time tₙ. As a result of the movement of shadow 1101 within tile A, temporal shade rate controller 403 has set a relatively high temporal reshading rate for tile A. By contrast, at time tₙ the content of tile B is static and the temporal shade rate controller 403 has set a relatively low temporal reshade rate for tile B. FIG. 11B depicts the same scene at a later time tₖ, after shadow 1101 has moved through tile A. In FIG. 11B, shadow 1101 is moving across tile B in the direction of the arrow at time tₖ. As a result of the movement of shadow 1101 within tile B, temporal shade rate controller 403 has set a relatively high temporal reshading rate for tile B. By contrast, at time tₖ the content of tile A is relatively static and the temporal shade rate controller 403 has set a relatively low temporal reshade rate for tile B.

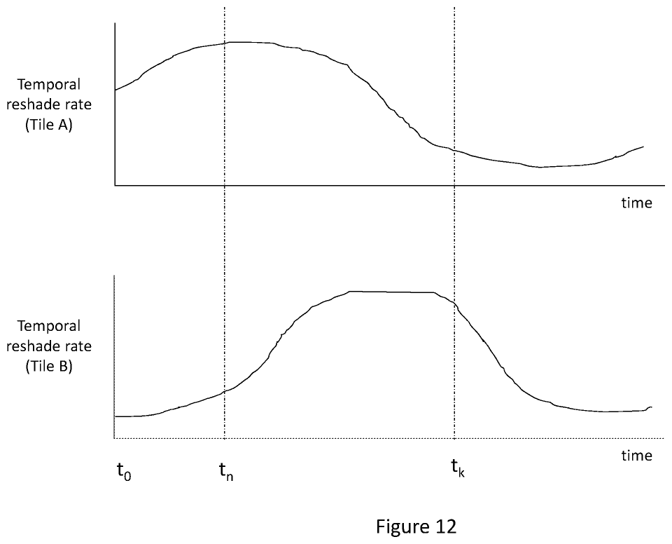

FIG. 12 are graphs illustrating the temporal shade rates of tiles A and B over time. As shown, at time to, temporal shade rate controller 403 set a higher temporal reshade rate for tile A and a lower temporal reshade rate for tile A. Having different temporal reshading rates across neighboring tiles (e.g., tiles A and B) has the potential to result in visually perceptible artifacts. For example, in some situations the higher temporal reshading rate for tile A might cause tile A to appear flickering while neighboring tile B is static. In order to reduce the possibility of such artifacts, temporal shade rate controller 403 applies an equalization at time tₒ to the temporal shade rates for tiles A and B. To implement the equalization, temporal shade rate controller 403 reduces the difference in the temporal shading rates of tiles A and B at time to by, e.g., increasing the temporal shade rate of tile B, lowering the temporal shading rate of tile A, or some combination of both. In some examples, a difference still remains between the temporal shade rates of tiles A and B after equalization but that difference is smaller than the difference in shading rates absent equalization.

As described above in connection with FIG. 11A, at time tₙ shadow 1101 is moving across tile A while the content of tile B is relatively static and, as shown in FIG. 12, at time tₙ there is also a discrepancy between the temporal shading rates of tiles A and B (tile A has a higher temporal shading rate than tile B). In this example, the discrepancy in temporal shading rates at time tₙ is driven by the fact that the content is changing more quickly in tile A than tile B. In this example, at time tₙ, temporal shade rate controller 403 reduces the difference in the temporal shading rates of tiles A and B by increasing the temporal shade rate of tile B, lowering the temporal shading rate of tile A, or some combination of both.

As described above in connection with FIG. 11B, at time tₖ shadow 1101 is moving across tile B while the content of tile A is relatively static and, as shown in FIG. 12, at time tₖ there is also a discrepancy between the temporal shading rates of tiles A and B (tile B has a higher temporal shading rate than tile A). In this example, the discrepancy in temporal shading rates at time tₖ is driven by the fact that the content is changing more quickly in tile B than tile A. In this example, at time tₖ, temporal shade rate controller 403 reduces the difference in the temporal shading rates of tiles A and B by increasing the temporal shade rate of tile A, lowering the temporal shading rate of tile B, or some combination of both.

In various examples, temporal shade rate controller 403 analyzes different parameters in order to determine whether temporal shade rate equalization should be applied to neighboring tiles. Examples of such parameters include the relative or absolute discrepancy in temporal shade rates, a discrepancy in temporal shade rates driven by content, historical temporal shading rates, probability of a content change, or the derivative of the rate of change in temporal shading rates.

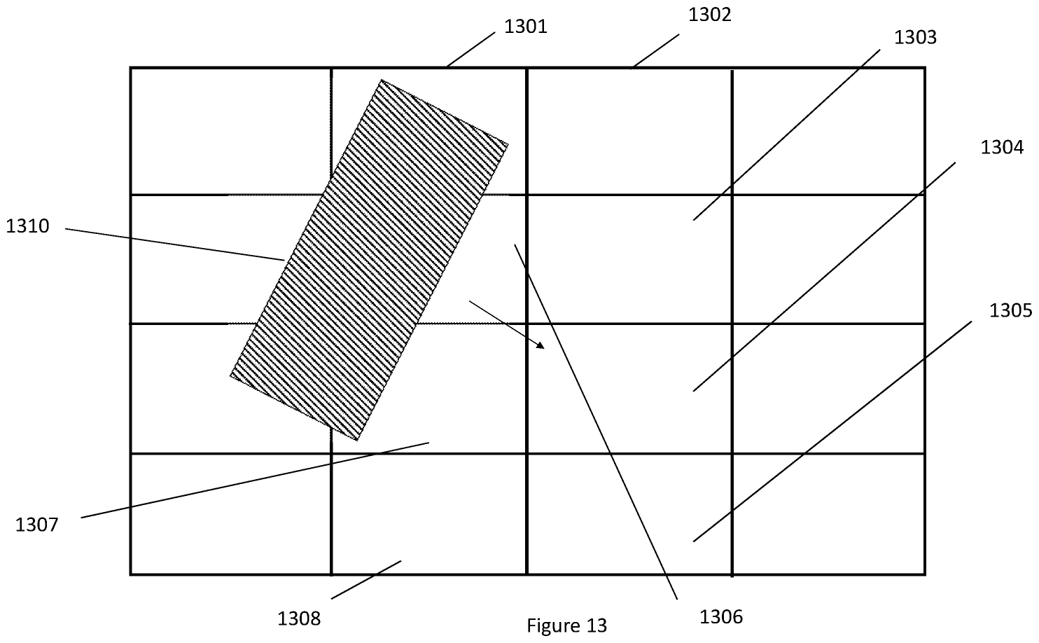

FIG. 13 is a further example for illustrating application of temporal shade rate equalization spatially. While in FIGS. 11A-B and 12, temporal rate equalization was applied between two neighboring tiles, in the example of FIG. 13, temporal shade rate equalization is applied to a larger number of neighboring tiles. In the example of FIG. 13, shadow 1310 is moving in the direction of the arrow across a number of tiles including tiles 1301, 1306 and 1307. In this example, the temporal shade rate for tile 1307 is relatively higher than that of neighboring tiles 1304, 1305 and 1308. In this example, temporal shade rate equalization is applied to, e.g., all three neighboring 1304, 1305 and 1308 in order to provide equalization between the temporal shade rate of those tiles and tile 1307. Similarly, the temporal shade rate for tile 1306 (which is relatively higher than that of neighboring tiles 1302, 1303 and 1304) may be equalized with the temporal shade rate of such neighboring tiles.

In some examples, an advantage of temporal rate equalization is that it provides early notice to neighboring tiles of an upcoming change in content. For example, referring back to FIG. 11A, the equalization that occurred at time tₙ provided early notice to tile B of an upcoming content change which, in that case, corresponded to movement of shadow 1101 across tile B.

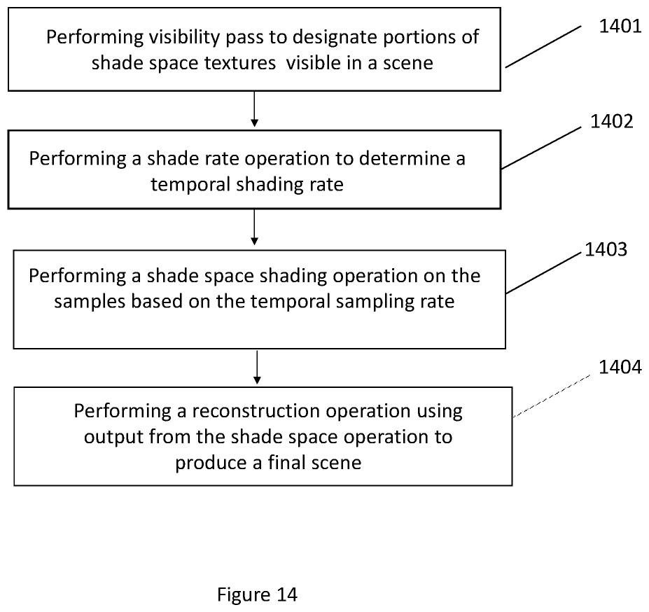

FIG. 14 is a flow diagram of a method for implementing adaptive temporal shading rates. In step 1401, visibility pass and texture marking operation 402 performs a visibility pass which designates portions of shade space textures visible in a scene. The visibility pass generates tiles that cover the shade space textures visible in the scene. In step 1402, rate controller 403 determines a temporal shading rate. In step 1403, shade space shading operation 403 shades samples visible in the scene at the temporal shading rate set by the rate controller 403. In step 1404, a reconstruction operation is then performed to produce a final scene.

In some examples, the temporal rate controller operation and the shade space operation are iteratively performed, and the output of the temporal controller operation is based on feedback from the shade space shading operation. In some examples, the temporal rate controller operation compares values of spatially-corresponding samples output during first and second iterations of the shade space shading operation, and adjusts or maintains the temporal shading rate based on a result of the comparing. In some of these examples, the temporal shading is increased if one or more differences between the spatially-corresponding samples output during the first and second iterations of the shade space shading operation exceed a threshold. In other examples, temporal shade rate equalization occurs between neighboring tiles.

In some examples, shaded samples are cached for reuse over a plurality of iterations of the shade space shading operation, and the temporal shading rate output by the temporal rate controller operation is implemented in accordance with a predetermined budget of samples to be shaded in the shade space shading operation. In some of these examples, an optimum temporal shading rate is selected for the shade space shading operation in order to minimize the visual and perceptible impact of applying only a subset of samples to the shade space shading operation.

In some examples, the reconstruction operation is part of a sequence of reconstruction intervals; the shade space shading operation is part of a sequence of shade space shading frames; and the sequence of reconstruction intervals is processed at a higher frequency than the sequence of shade space shading frames.

It should be understood that many variations are possible based on the disclosure herein. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the command processor 136, compute units 132, SIMD units 138, input assembler stage 302, vertex shader stage 304, hull shader stage 306, tessellator stage 308, domain shader stage 310, geometry shader stage 312, rasterizer stage 314, pixel shader stage 316, or output merger stage 318 are implemented fully in hardware, fully in software executing on processing units, or as a combination thereof. In various examples, such “hardware” includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for rendering, the method comprising:
performing a visibility pass that designates portions of shade space textures visible in a scene, wherein the visibility pass generates tiles that cover the shade space textures visible in the scene;
performing a temporal rate controller operation;
performing a shade space shading operation on the tiles that cover the shade space textures visible in the scene based on a temporal shading rate output by the temporal rate controller operation, wherein only a subset of samples in the tiles that cover the shade space textures visible in the scene are shaded in the shade space shading operation; and
performing a reconstruction operation using output from the shade space shading operation to produce a final scene.

2. The method of claim 1, wherein the temporal rate controller operation and the shade space shading operation are iteratively performed, and the output of the temporal rate controller operation is based on feedback from the shade space shading operation.

3. The method of claim 2, wherein the temporal rate controller operation further comprises:
(i) comparing values of spatially-corresponding samples output during first and second iterations of the shade space shading operation; and
(ii) adjusting or maintaining the temporal shading rate based on a result of the comparing.

4. The method of claim 3, wherein the temporal shading rate is increased if one or more differences between the spatially-corresponding samples output during the first and second iterations of the shade space shading operation exceed a threshold.

5. The method of claim 2, wherein shaded samples are cached for reuse over a plurality of iterations of the shade space shading operation.

6. The method of claim 1, wherein the temporal shading rate output by the temporal rate controller operation is implemented in accordance with a predetermined budget of samples to be shaded in the shade space shading operation.

7. The method of claim 6, wherein an optimum temporal shading rate is selected for the shade space shading operation in order to minimize visual and perceptible impact of applying only a subset of samples to the shade space shading operation.

8. The method of claim 1, wherein:
the reconstruction operation is part of a sequence of reconstruction intervals;
the shade space shading operation is part of a sequence of shade space shading frames; and
the sequence of reconstruction intervals is processed at a higher frequency than the sequence of shade space shading frames.

9. A system comprising:
a processor; and
a memory storing instructions that, when executed by the processor, cause the processor to perform operations including:
performing a visibility pass that designates portions of shade space textures visible in a scene, wherein the visibility pass generates tiles that cover the shade space textures visible in the scene;
performing a temporal rate controller operation;
performing a shade space shading operation on the tiles that cover the shade space textures visible in the scene based on a temporal shading rate output by the temporal rate controller operation, wherein only a subset of samples in the tiles that cover the shade space textures visible in the scene are shaded in the shade space shading operation; and
performing a reconstruction operation using output from the shade space shading operation to produce a final scene.

10. The system of claim 9, wherein the temporal rate controller operation and the shade space shading operation are iteratively performed, and the output of the temporal rate controller operation is based on feedback from the shade space shading operation.

11. The system of claim 10, wherein the temporal rate controller operation further comprises:
(i) comparing values of spatially-corresponding samples output during first and second iterations of the shade space shading operation; and
(ii) adjusting or maintaining the temporal shading rate based on a result of the comparing.

12. The system of claim 11, wherein the temporal shading rate is increased if one or more differences between the spatially-corresponding samples output during the first and second iterations of the shade space shading operation exceed a threshold.

13. The system of claim 10, wherein shaded samples are cached for reuse over a plurality of iterations of the shade space shading operation.

14. The system of claim 9, wherein the temporal shading rate output by the temporal rate controller operation is implemented in accordance with a predetermined budget of samples to be shaded in the shade space shading operation.

15. The system of claim 14, wherein an optimum temporal shading rate is selected for the shade space shading operation in order to minimize visual and perceptible impact of applying only a subset of samples to the shade space shading operation.

16. The system of claim 9, wherein:
the reconstruction operation is part of a sequence of reconstruction intervals;
the shade space shading operation is part of a sequence of shade space shading frames; and
the sequence of reconstruction intervals is processed at a higher frequency than the sequence of shade space shading frames.

17. A non-transitory computer-readable medium storing instructions that, when executed by a processor, cause the processor to perform operations comprising:
performing a visibility pass that designates portions of shade space textures visible in a scene, wherein the visibility pass generates tiles that cover the shade space textures visible in the scene;
performing a temporal rate controller operation;
performing a shade space shading operation on the tiles that cover the shade space textures visible in the scene based on a temporal shading rate output by the temporal rate controller operation, wherein only a subset of samples in the tiles that cover the shade space textures visible in the scene are shaded in the shade space shading operation; and
performing a reconstruction operation using output from the shade space shading operation to produce a final scene.

18. The non-transitory computer-readable medium of claim 17, wherein the temporal rate controller operation and the shade space shading operation are iteratively performed, and the output of the temporal rate controller operation is based on feedback from the shade space shading operation.

19. The non-transitory computer-readable medium of claim 18, wherein shaded samples are cached for reuse over a plurality of iterations of the shade space shading operation.

20. The non-transitory computer-readable medium of claim 17, wherein the temporal shading rate output by the temporal rate controller operation is implemented in accordance with a predetermined budget of samples to be shaded in the shade space shading operation.
